(19) United States
(12) Patent Application Publication
(10) Pub. No.: US 2011/0235807 A1
(43) Pub. Date: Sep. 29, 2011

(54) AUDIO OUTPUT DEVICE

(75) Inventors: Takayuki Hayashi, Kyoto (JP); Yoichi Sugino, Osaka (JP)

(73) Assignee: PANASONIC CORPORATION, Osaka (JP)

(21) Appl. No.: 13/039,014

(22) Filed: Mar. 2, 2011

(30) Foreign Application Priority Data
Mar. 23, 2010 (JP) 2010-066037
Nov. 15, 2010 (JP) 2010-254358

(51) Int. Cl. H04R 5/00

(52) U.S. Cl. 381/17

(57) ABSTRACT

An audio output device is provided that can output sound with a sound field environment, sound quality, and a range suitable for a viewer. The audio output device includes: audio output units 13a and 13b for outputting sound; a control unit for controlling a sound field by controlling the audio output units 13a and 13b; and detection units 2 and 5 for detecting the viewing position of the viewer. The control unit controls the sound field according to the viewing position of the viewer. Further, an audio output device includes: audio output units for outputting sound; a control unit for controlling a sound field by controlling the audio output units; and a detection unit for detecting a viewer and estimating an age of the viewer. The control unit controls one of volume and a range according to the estimated age.

### FIELD OF THE INVENTION

The present invention relates to an audio output device. Particularly, the present invention relates to an audio output device that can create a sound field or control sound quality and volume in response to the state of a viewer.

### BACKGROUND OF THE INVENTION

In recent years, large screen televisions have become widely available and there has been a growing demand for viewing large screen televisions combined with audio systems that add a sense of realism. However, a viewer has to stay in a predetermined area to feel a sense of realism. In the case of multiple viewers, some of the viewers may stay out of the area and have to view video with reduced realism.

Japanese Patent Laid-Open No. 2007-28134 discloses a cellular phone as a related art technique for solving the problem of reduced realism. The cellular phone includes two adjacent speakers and an autofocus camera. Further, the cellular phone transmits impulse sound waves from the speakers and has a microphone for detecting the impulse sound waves reflected from the head of a listener. A distance between the listener and the speakers is measured by using these constituent elements and the measurement result is reflected on a filter factor by using, e.g., a head transfer function in a database, so that stereophonic sound can be satisfactorily obtained.

### DISCLOSURE OF THE INVENTION

In the cellular phone disclosed in Japanese Patent Laid-Open No. 2007-28134, a distance between the two speakers and the head (ears) of a listener is detected by using the autofocus function of the camera and the distance is reflected on the head transfer function and filter characteristics for realizing the function. Thus, for example, in the case of a television having the same function, a distance from a viewer may be less accurately measured and stereophonic sound may not be satisfactorily obtained as expected.

Moreover, the autofocus function cannot detect the positions of multiple viewers and calculate the ages of the viewers. Thus it is not possible to provide stereophonic sound according to the positions of multiple viewers and the ages of the viewers. In other words, the optimum values of a range and volume vary with age and thus stereophonic sound cannot be provided according to the age of a viewer. It has been requested to solve this problem and achieve a function for automatically optimizing a sound field environment, sound quality, and a range according to the positions of multiple viewers and the ages of the viewers.

The present invention has been devised to solve the problem of the related art. An object of the present invention is to provide an audio output device that can output sound with a sound field environment, sound quality, and a range suitable for a viewer.

In order to attain the object, an audio output device includes: an audio output unit for outputting sound; a control unit for controlling a sound field by controlling the audio output unit; and a detection unit for detecting the viewing position of a viewer, wherein the control unit controls the sound field according to the viewing position of the viewer.

Further, in order to attain the object, an audio output device includes: an audio output unit for outputting sound; a control unit for controlling a sound field by controlling the audio output unit; and a detection unit for detecting a viewer and estimating the age of the viewer, wherein the control unit controls one of volume and a range according to the estimated age.

The present invention can provide an audio output device that can output sound with a sound field environment, sound quality, and a range suitable for a viewer.

### BRIEF DESCRIPTION OF THE DRAWINGS

FIG. 1 is a structural diagram schematically showing the configuration of a television including an audio output device according to a first embodiment of the present invention;

FIG. 2 is a plan view showing the relative positions of the television including the audio output device and a viewer according to the first embodiment of the present invention;

FIG. 3 is a plan view showing the relative position of the viewer displaced from the center of the television;

FIG. 4 shows hearing losses of Japanese by age group (hearing test);

FIG. 5 shows a display example of registration information about each viewer;

FIG. 6 is a plan view showing the relative positions of multiple viewers; and

FIG. 7 shows a display example of viewers identified by face recognition.

### DESCRIPTION OF THE EMBODIMENTS

The following will describe embodiments of the present invention in accordance with the accompanying drawings.

### First Embodiment

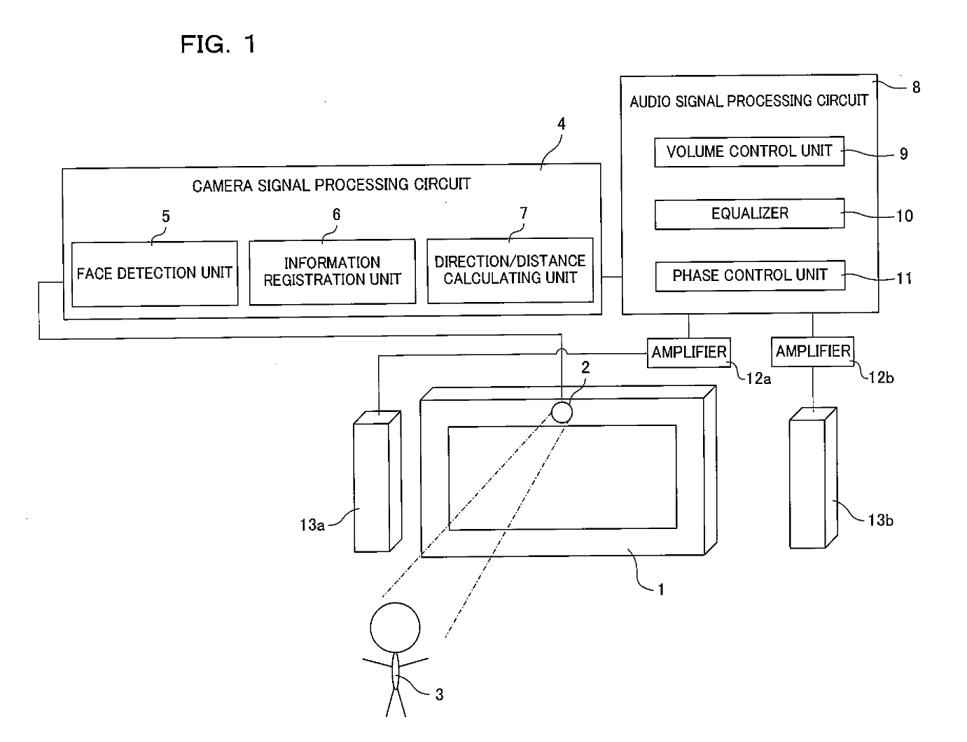

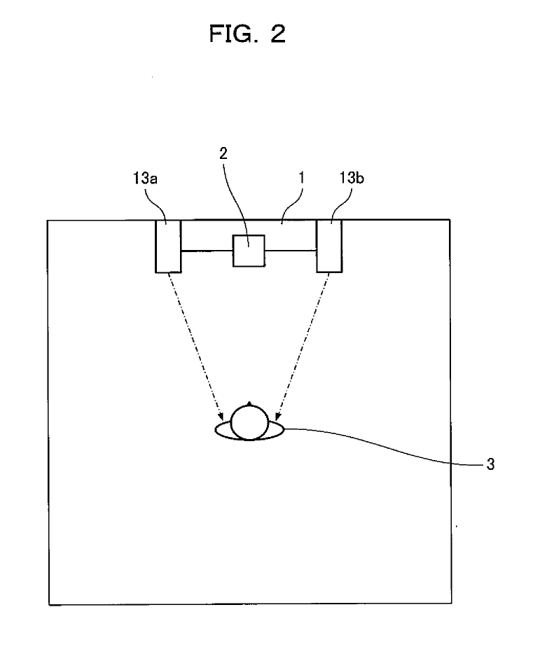

In the present embodiment, an audio output device is provided in a television that acts as a display audio output device. As shown in FIGS. 1 and 2, the display audio output device (audio output device) includes: a television body 1 acting as a display unit for displaying video; an audio signal output unit made up of left and right speakers 13a and 13b and amplifiers 12a and 12b; an audio signal processing circuit 8 acting as a control unit; and a detection unit made up of a camera 2 installed on the television body 1 and a camera signal processing circuit 4. A viewer 3 is imaged by the camera 2. In the present embodiment, not only the audio signal processing circuit 8 but also a part of the camera signal processing circuit 4 functions as a control section.

An image from the camera 2 undergoes predetermined signal processing in the camera signal processing circuit 4 to create image information, and the face of the viewer 3 is detected from the image information by a face detection unit 5 of the camera signal processing circuit 4. Further, based on information about the detected face, a direction/distance calculating unit 7 of the camera signal processing circuit 4 calculates the number of viewers 3 and the direction and the distance of the viewer 3 with respect to the television body 1. The distance of the viewer 3 is calculated based on the focal distance of the camera 2, the size of the imaging part (not shown) of the camera 2, the number of pixels in the imaging part, the number of pixels actually used for imaging in the imaging part, and the average size of human faces (e.g., a human face is about 16 cm in width).

Based on direction information and distance information that have been calculated by the direction/distance calculating unit 7 for the viewer 3 with respect to the television body 1, volume and a phase are controlled by a volume control unit 9 provided in the audio signal processing circuit 8, an equalizer 10 for adjusting a gain at an audio frequency, and a phase control unit 11 for controlling the output phases of the left and right speakers 13a and 13b. The volume control unit 8 increases volume to the speakers 13a and 13b through the amplifiers 12a and 12b in the case of a large distance from the viewer 3, and reduces the volume in the case of a short distance from the viewer 3.

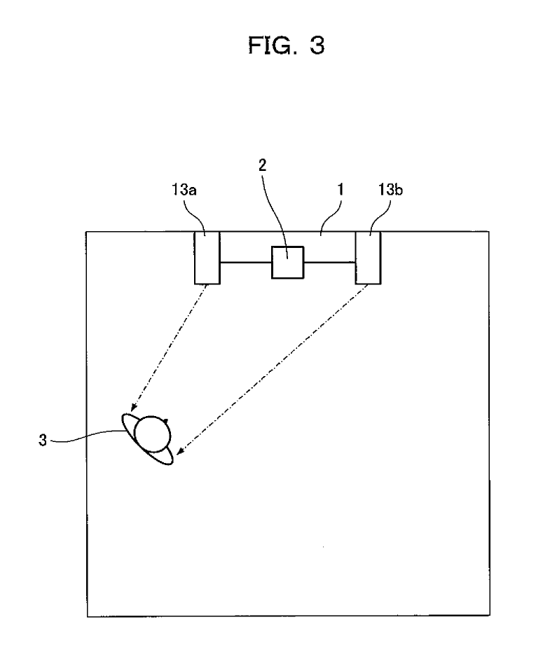

As shown in FIG. 3, when the viewer 3 is laterally displaced from the television body 1, the phase control unit 11 performs phase control by the amount of lateral displacement based on the direction information, thereby creating a natural sound field for the viewer 3.

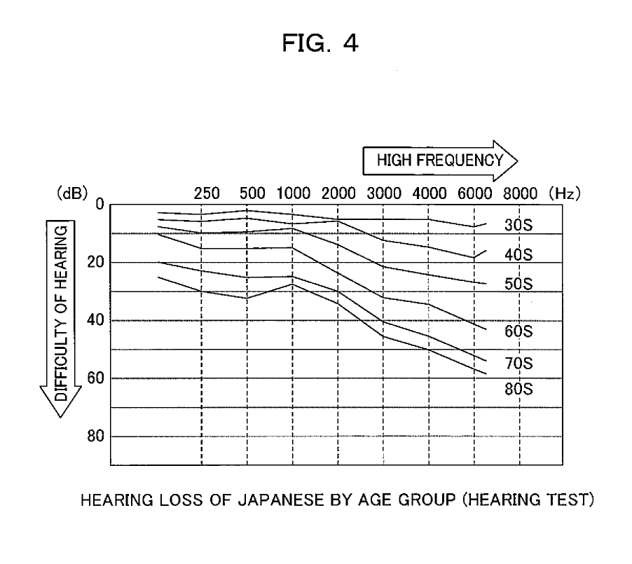

FIG. 4 shows hearing losses of Japanese by age group. As shown in FIG. 4, hearing fades with age, particularly in the high-frequency range. The face detection unit 5 of the camera signal processing circuit 4 can estimate the age of the viewer 3 based on the image information about the detected face. When it is decided that the viewer 3 is an elderly person, the volume control unit 9 increases volume and the equalizer 10 optimizes the gain of the high-frequency range. Thus an automatic correction is made for a hearing loss of an elderly person in the high-frequency range and volume in the high-frequency range is increased, always offering ease of hearing.

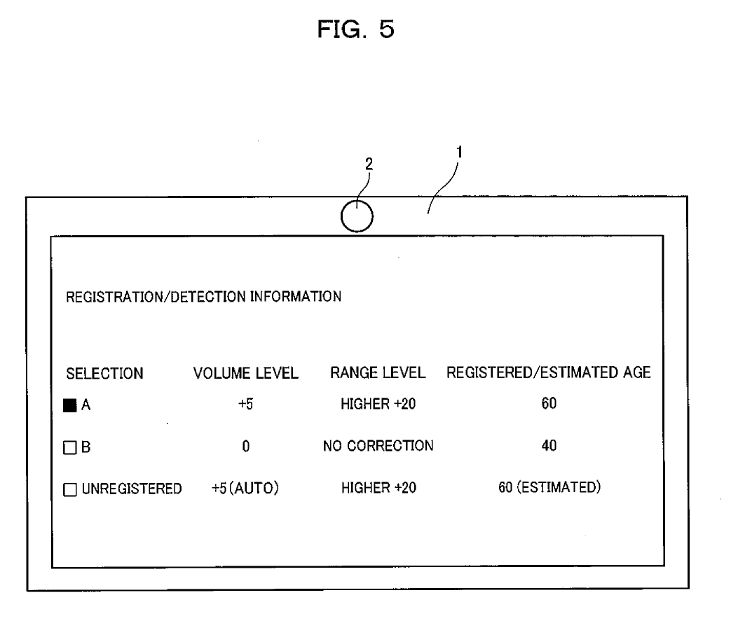

Further, the face of the viewer 3 is photographed by the camera 2 and face information from the photographed image is registered beforehand by an information registration unit 6 provided in the camera signal processing circuit 4. Further, it is decided whether or not face information about the viewer 3 is the same as the registered face information, so that the viewer is identified by the face information. Moreover, the age and the desired volume and sound quality of each registered viewer 3 are also registered beforehand by the information registration unit 6. Registration is performed by, e.g., a remote controller (not shown) that is an attachment of the television body 1. As shown in FIG. 5, the television body 1 can display the registered information (age, desired volume and sound quality) about the viewer 3.

With this configuration, the camera signal processing circuit 4 performs the predetermined signal processing on an image photographed by the camera 2 for the viewer 3 during viewing, and the face detection unit 5 detects the face of the viewer 3. Further, the detected face is compared with faces registered by the information registration unit 6. When it is decided that the detected face is identical to one of the registered faces, the audio output conditions are automatically set at desired conditions based on the registration. When the face of the viewer 3 is detected in this configuration, the audio output conditions registered for the viewer 3 are automatically set, always offering ease of hearing.

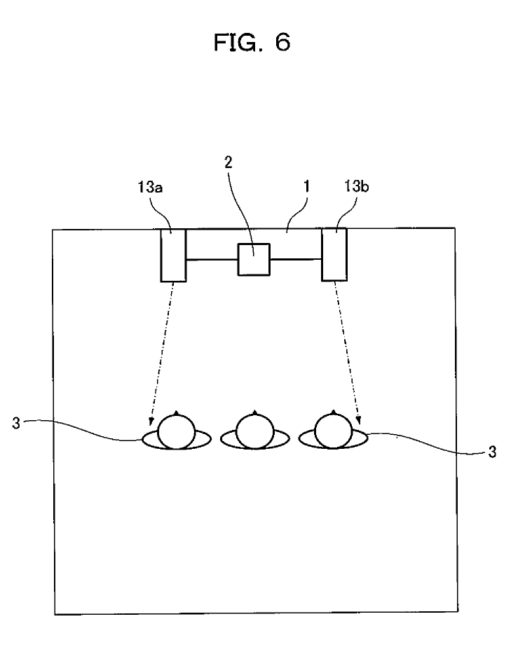

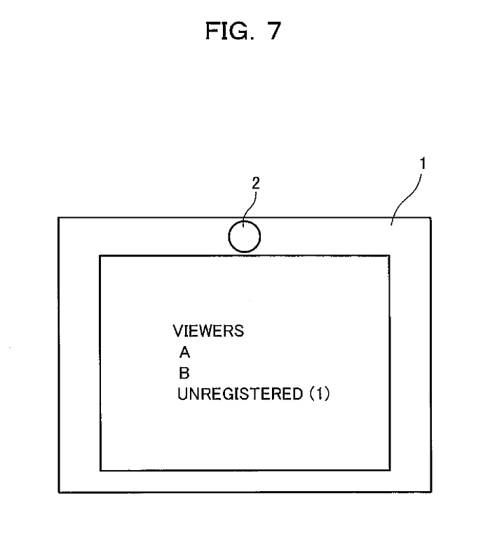

When the faces of the multiple viewers 3 are detected as shown in FIG. 6, detection information is displayed on the screen of the television body 1 as shown in FIG. 7 or FIG. 5. In the case where detected face information about the viewer 3 is identical to a registered face, the registered name and set adjustment specifications of the viewer 3 are displayed. In the case where an unregistered face is detected, an amount of adjustment is automatically set according to a detected estimated age. In the case where the multiple viewers 3 (information about multiple faces) are detected, any settings can be selected, for example, settings such as volume for one of the viewers 3 may be selected or the average value (volume) of volume for all the viewers 3 may be selected. Further, when multiple viewers are detected, the positions of the viewers are measured and the phase control unit 11 controls a displacement of lateral audio output according to the positions.

In the present embodiment, the speakers 13a and 13b are 2ch speakers of L and R. The present embodiment may be applied to 5.1ch and 7.1ch surround sound systems. In the present embodiment, a distance is detected based on the width of a face but a distance may be measured based on statistical data including a distance between eyes and the length of a head.

In the present embodiment, the information registration unit 6 is provided in the camera signal processing circuit 4. The present invention is not limited to this configuration and the information registration unit 6 may be provided anywhere in the audio output device. For example, the information registration unit 6 may be provided in the audio signal processing circuit 8. The remote controller is used as an information registration device but the registration device is not particularly limited to a remote controller. For example, registration may be inputted through a connected keyboard or the gesture recognition of the viewer 3 with the camera 2, that is, through the input of gestures.

### Second Embodiment

A second embodiment of the present invention will be described below. The explanation of the same parts as the first embodiment is omitted.

A camera 2 includes an adjustment mechanism (not shown) that can adjust a relative angle between a television body 1 and the camera 2 according the installation location of the television body 1 during the installation of the television body 1. During the installation, the optimum orientation of the camera 2 (specifically, the orientation of the lens of the camera 2) is adjusted beforehand. Further, the relative angle between the camera 2 and the television body 1 can be stored in an information registration unit 6. Moreover, when the direction of a viewer 3 is detected, the detected angle of the viewer 3 is calibrated based on the information of the information registration unit 6. Thus an orientation error of the camera can be corrected in the initial setting, thereby correctly detecting the direction of the viewer 3 regardless of the installation state.

The present embodiment described the relative angle of the camera 2 included in the television body 1. The camera of the present embodiment is not particularly limited to this and an external camera may be used as long as an angular difference can be detected between the installation directions of the television body 1 and the camera. For example, an angle sensor may be provided. Further, an angle error may be inputted beforehand as a numeric value. Moreover, a driving source such as a motor may be provided for changing the orientation of the camera 2, a sensor may be provided for detecting the angle of movement, and a direction to the viewer 3 may be detected while changing the orientation of the camera 2 to the viewer 3.

### Effects of the Embodiment

According to the foregoing embodiments, the television body 1 includes the camera 2, and the number of viewers 3 and the positions and ages of the viewers 3 are detected through an image of the camera 2. Further, a sound field environment, sound quality, and a range are controlled based on the information suitable for each of the viewers 3. Thus it is possible to create a sound field with a sense of realism and a sound field giving ease of hearing.

Moreover, the viewer 3 is identified based on information such as preregistered face information and sound is outputted based on preset audio output information, achieving the optimum sound environment for each of the viewers 3.

The television body 1 further includes the adjustment mechanism that can adjust the orientation of the camera 2. By correcting an orientation error of the television and the camera, the position and direction of the viewer 3 can be correctly detected. Thus it is possible to increase flexibility in the installation of equipment (including the television body 1, the camera 2, and the speakers 13a and 13b) and facilitate the adjustment.

The present invention is suitable for an audio output device provided with a display device and an audio output part, e.g., a television. The present invention is also applicable to, e.g., an extra-large display device used for a large number of viewers outdoors. The present invention is further applicable to, e.g., an audio output device provided with no display devices and various audio output devices that output sound in a space.

What is claimed is:

1. An audio output device comprising:
an audio output unit for outputting sound;
a control unit for controlling a sound field by controlling the audio output unit; and
a detection unit for detecting a viewing position of a viewer,
wherein the control unit controls the sound field according to the viewing position of the viewer.

2. The audio output device according to claim 1, wherein the detection unit detects the position of the viewer by recognizing a face of the viewer.

3. The audio output device according to claim 1, wherein when the detection unit detects multiple viewers, the control unit controls the sound field according to positions of the viewers.

4. An audio output device comprising:
an audio output unit for outputting sound;
a control unit for controlling a sound field by controlling the audio output unit; and
a detection unit for detecting a viewer and estimating an age of the viewer,
wherein the control unit controls one of volume and a range according to the estimated age.

5. The audio output device according to claim 4, further comprising an information registration unit that previously registers detection information about a viewer and viewer-specific information about at least one of an age, a volume level, and a range level for the viewer such that the detection information and the viewer-specific information are associated with each other,
wherein when the viewer detected by the detection unit is identical to the viewer registered in the information registration unit, the control unit controls one of the volume and the range according to the viewer-specific information about the viewer.

6. The audio output device according to claim 1, further comprising a detection unit adjustment mechanism for adjusting a position of the detection unit for detecting the viewing position of the viewer.

7. The audio output device according to claim 1, further comprising a display unit for displaying video,
wherein the detection unit detects, as a viewer, a person in a region enabling viewing of the display unit.
